(19) United States
(12) Patent Application Publication
(10) Pub. No.: US 2016/0062101 A1
(43) Pub. Date: Mar. 3, 2016

(54) METHOD AND APPARATUS FOR SMALL AND LARGE FORMAT HISTOLOGY SAMPLE EXAMINATION

(71) Applicant: WDI WISE DEVICE INC., Markham (CA)

(72) Inventors: Adam WEISS, Toronto (CA); Andrzej LASINSKI, Mississauga (CA)

(21) Appl. No.: 14/781,813

(22) PCT Filed: Apr. 8, 2014
(86) PCT No.: PCT/CA2014/050354

§ 371 Date: Oct. 1, 2015

Related U.S. Application Data
(60) Provisional application No. 61/809,589, filed on Apr. 8, 2013.

(51) Int. Cl. G02B 21/36; H04N 5/44; G06K 9/46; H04N 5/232; G02B 21/24; G02B 21/26

(52) U.S. Cl. CPC G02B 21/365; G02B 21/367; G02B 21/248; G02B 21/26; G02B 21/368; G06K 9/46; H04N 5/23293; H04N 5/44; G06K 2009/4666

(57) ABSTRACT

The disclosure is directed at a method and apparatus for small and large format histology examination. By providing a pair of networked processors and by linking one processor with a microscope, control of the microscope may be performed at a remote location. Further, by transmitting low magnification images, a reviewer may determining a region of interest before having a higher magnification image captured thereby reducing the data storage required for this histology examination.

### CROSS-REFERENCE TO RELATED APPLICATIONS

This application claims the benefit of U.S. Provisional Application No. 61/809,589 filed Apr. 8, 2013 which is hereby incorporated by reference in its entirety.

### FIELD OF THE DISCLOSURE

In general, the disclosure relates generally to the field of optical microscopy. More specifically the disclosure relates to a method and apparatus for small and large format histology sample examination.

### BACKGROUND OF THE DISCLOSURE

In typical day-to-day operation, pathologists examine histopathology samples with the assistance of an optical microscope. This is, at least partly, due to the fact that the regulatory bodies have not yet approved digital imaging as a diagnostic tool.

The size of a histopathology sample is usually very large compared to the microscope field of view (FOV). In order to examine an entire sample, pathologists normally overview them under low magnification (around 2×), but are still able to only observe a fraction of the sample area at a time. Once the region of interest (ROI) is found on the sample, the microscope is switched to one of higher magnifications (×5, ×10, ×20 or ×40) to reveal finer cellular and/or sub cellular details.

Selecting these higher magnifications reduces the microscope FOV even further (the higher magnification, the smaller the FOV), which results in the loss of contextual information (i.e. the morphology of the area surrounding of ROI). For small sample histopathology evaluation (typically 15 mm by 15 mm), this is an inconvenience leading to the loss of evaluation efficiency due to unnecessarily repeated observations. The loss of contextual information becomes a major technological barrier in the examination of large and very large specimens or samples such as—for instance—those prepared in the review of whole breast mastectomies or prostatectomy.

One known method of assuring that the contextual information is always available is to electronically record the image of the entire histopathology sample under high magnification (this is typically accomplished using specialized slide scanners). Such a method is typically referred to as the Whole Slide Imaging (WSI) technique. WSI allows for the digital zooming out of the high-resolution image to present it at low magnification as the overview image covering the entire sample or large fragment of it. Since the high-resolution image is always available, the reviewer may zoom-in digitally on the selected ROI choosing suitable magnification to the maximum of the one corresponding to the magnification at which the high resolution image was collected—typically 20×.

This method has numerous disadvantages including that the histopathology evaluation is performed using the image of the slide not the slide itself. This renders the WSI useful for research or educational applications only and not suitable for clinical ones, where real slides must be reviewed under the optical microscope. Also, in the case of a large format histology (5″ by 7″ slide size), WSI generates a large amount of data such that if when 20× magnification is used, the typical image size for a large format histology slide will be close to 20 GB. Out of this massive amount of information only a few percent represents the diagnostic information; the rest is just a healthy tissue, which is normally skipped in a conventional examination method and therefore, there is a lot of storage space required for a small amount of necessary information. Another disadvantage is that as the field of histopathology turns to 3D large format histology, the whole mastectomy is divided into 35 to 45 slices, and then a whole mount slide is prepared per slice. This means that 3D large format histology data set would generate 700 to 900 GB of information and again only a small percentage of it is useful. Data files of this size are very difficult to manage and/or store for practical applications. Also, scanning large format histology slides at 20× magnification requires a long time to complete and lasts prohibitively long: ˜1.7 hours per 5″×7″ slide and 58 hours for the 3D data set of 35 slides. This may not be beneficial where the time to review the sample is limited. Another disadvantage is that if other than conventional microscopy observation methods are required such as fluorescence or confocal, in WSI, the entire slide has to be scanned thereby multiplying the data file size and acquisition time by the number of extra observation techniques applied which, in turn, aggravates the above mentioned deficiencies even further. Moreover, if the slide is scanned at 20× magnification, to keep scanning time and data file size somewhat reasonable, then the maximum zoom in capability is limited to 20× magnification as well, meaning detailed examination at magnifications such as 40× or 80× is not possible.

Therefore, there is provided a method and apparatus which overcomes disadvantages of the prior art.

### BRIEF DESCRIPTION OF THE DRAWINGS

Embodiments of the present disclosure will now be described by way of example only, with reference to the attached Figures.

FIG. 1 is a schematic diagram of apparatus for histology sample examination;

FIG. 2 is a flowchart outlining a method of histology sample examination; and

FIG. 3 is a flowchart outlining another method of histology sample examination

### DETAILED DESCRIPTION OF THE DISCLOSURE

The disclosure is directed at a method and apparatus for small and large format histology sample or samples examination. In one embodiment, the method and apparatus allow for the histology sample examination to be performed by an individual or individuals who are located remotely from the where the sample or samples are located. In one advantage of the current disclosure, time-sensitive examination of samples may be performed without an individual, such as a pathologist, being physically present as is currently required. In another embodiment, the histology examination may be performed in close proximity to the microscope.

In one example, when a surgery is being performed and there is a need to get an immediate understanding of the tumor that has been extracted, current technologies require a pathologist on site to immediately review the sample as time is of the essence. The pathology examination is performed after the surgery often revealing the need of immediate repeated operation for removal of the tumor residues from the surgeryical margins. This may be problematic when the surgery is being performed in locations where there is no easy access to pathologists and therefore surgeries may be delayed from being performed until a pathologist can travel to and arrive at the surgery location.

Also, current methods of capturing images of these samples for either storage or transmission results in large images which may not be able to be transmitted instantaneously to a remote location, further necessitating the presence of a pathologist on site during the surgery.

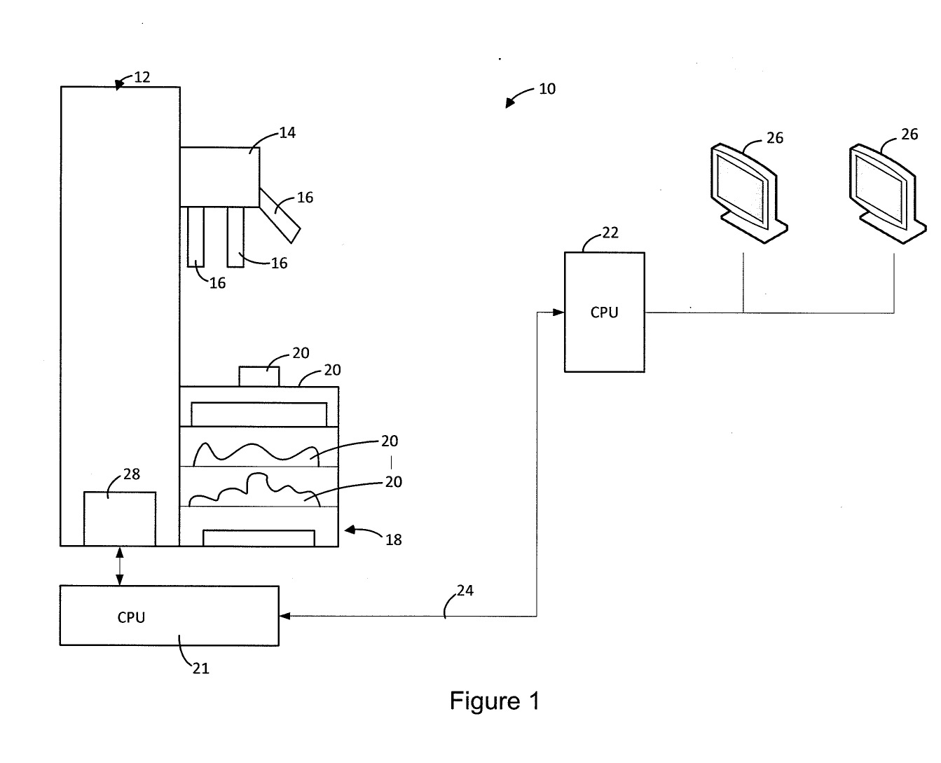

Turning to FIG. 1, a schematic diagram of apparatus for performing remote histology sample examination is shown. The apparatus 10 includes a microscope 12 with a lens changer 14 housing a plurality of lenses 16 each lens providing a different magnification level. The lenses 16 are used to provide images of samples 20 (located on individual slides) which are located on a motorized stage 18. As shown the motorized stage 18 contains the apparatus for receiving multiple, which in the current embodiment is five (5), different slides. Although only five are shown, any number of slides are possible as would be understood. Furthermore, there does not need to be a sample on every slide holder within the stage for operation of the motorized stage 18. Moreover, an automatic slide loader may be employed, for loading—from the cassette—single or multiple slides for examination onto the stage 18.

The motorized stage 18 is preferably controlled by a processor 21, such as a central processing unit (CPU), to move the different samples within the stage. In one embodiment, the slides are placed on the stage side by side. Typically, the slides are stacked in the autoloader cassette. The lens changer 14, the plurality of lenses 16 and the motorized stage 18 may operate together to provide tracking auto focus to assist in the histology sample examination. The microscope 12 is also preferably controlled via the processor 21.

The apparatus 10 further includes a second processor 22 which is located remote from the processor 21. In this example, the term remote means in a physical location which is different than the microscope. For instance, on a different floor, in another adjacent building, or even in a different city, country or continent. The two processors 21 and 22 communicate via a network 24, such as but not limited to, the Internet or a wide area network (WAN). Other types of known networks are also contemplated. The processor 22 is associated or in communication with at least one, but preferably two, displays 26 for displaying the images which are captured by the microscope 12 (as will be disclosed in more detail below). In a further embodiment of the disclosure, the two processors may be a single processor.

In use, a user of the processor 22 and displays 26 may control the images being displayed on the display via a display pointer, whereby a link between the computer pointer on one of the displays 26 and an electro mechanical servo mechanism 28 of the microscope 12 is enabled. This will allow the user to control where the microscope 12 is pointing to within the sample as indicated by the display pointer. In other words, the user may remotely control the positioning of the motorized XY stage with respect to the lens changer 14 or vice versa.

In one embodiment, the disclosure may be particularly useful for improving the efficiency and ergonomics of histology samples examined under the optical microscope 12. In another embodiment, this disclosure may be used in the examination of mounted biological samples such as tissue samples on microscope slides.

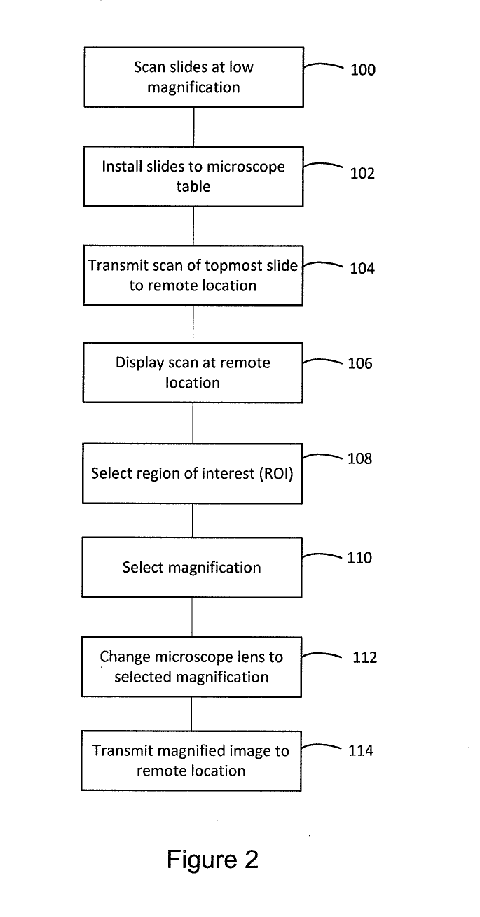

Turning to FIG. 2, a method of histology sample examination is shown. According to the one embodiment of the present disclosure, It is assumed that the slides have already been prepared with samples and are ready for review under the microscope. The slides may also be referred to as histology slides.

Initially, at 100, the histology slide is or slides are pre-scanned at a low resolution—such as at 2× magnification. This low magnification scan assists in obtaining an overview image of each histology slide. In another embodiment, the selected magnification level may be the same as the one a reviewer (such as a pathologist) uses when searching for a region of interest (ROI) or regions of interest (ROIs). If there is more than one slide loaded within the microscope or motorized stage, a scan is performed for each of these histology slides. In another embodiment, this pre-scanning may be performed using an upgraded slide review microscope for small histology samples and preferably on a stand-alone scanner for large format samples or slides. These pre-scans may then be stored in a database which may be accessed by a processor.

After the pre-scans have been completed, the slides are installed or mounted to a microscope XY table 102 which is controlled by the motorized stage. Depending on how many slides are being reviewed, (assuming there are enough places for each of these slides), the slides are installed on the table or within the stage. Alternatively, the pre-scan may be performed after the slides have been mounted to the motorized stage. In other words, the pre-scan and the mounting are interchangeable.

After the slides are installed, the pre-scan of the slide on the top of the stack is transmitted 104 to be shown 106 on a display at a remote location. In one embodiment, a processor associated with the microscope retrieves the pre-scan from a database and transmits it over a network to a second processor which is located remote from the first processor. The second processor then displays the pre-scan on a display or monitor associated with the second processor. The pre-scan image aids identification of ROIs as well as provides contextual information about the surroundings of ROI for the pathologist or reviewer at this location.

After the pre-scan is displayed, the pathologist or reviewer may select a region of interest (ROI) for closer review. In a preferred embodiment, the display area on the display or monitor is mapped to the area of XY range of motion of the motorized XY microscope stage by means of a calibration procedure. This is preferably completed prior to the operation of this method.

In one embodiment, the display pointer on the monitor displaying the pre-scan image is linked by an apparatus such as a XY servo mechanism with the XY motorized microscope table such that the microscope objective lens always points to the same spot as the one the display pointer on the computer monitor is pointing to.

Once the ROI is selected 108, the pathologist can control the lens changer by sending a command via the network to the first processor. In order to facilitate this command, the reviewer may simply have to click on an icon shown on the display. The change in lens allows the reviewer to control the microscope to select a magnification 110 at which the ROI is to be reviewed. This is achieved by the pathologist selecting a desired magnification, such as but not limited to 4×, 10×, 20×, 40× or even 80×, and then transmitting this instruction to the microscope (or lens changer) via the processors 21 and 22. After receiving the input from the processor 22, the processor 21 controls the lens changer 14 to rotate the lens to the selected lens/magnification 112 and focuses the lens at the ROI. The higher magnified image is then transmitted to a display at the remote location 114. In a preferred embodiment, the higher magnification image appears in a separate window or a separate computer monitor or display for ease of review.

In a preferred embodiment, the higher magnification images are nested. Once the reviewer or pathologist moves the display pointer to the higher magnification image of the ROI (on the second display), the pointer servo-links with the XY table and then the objective or lens is directed at the spot on the higher magnification image indicated by the display pointer.

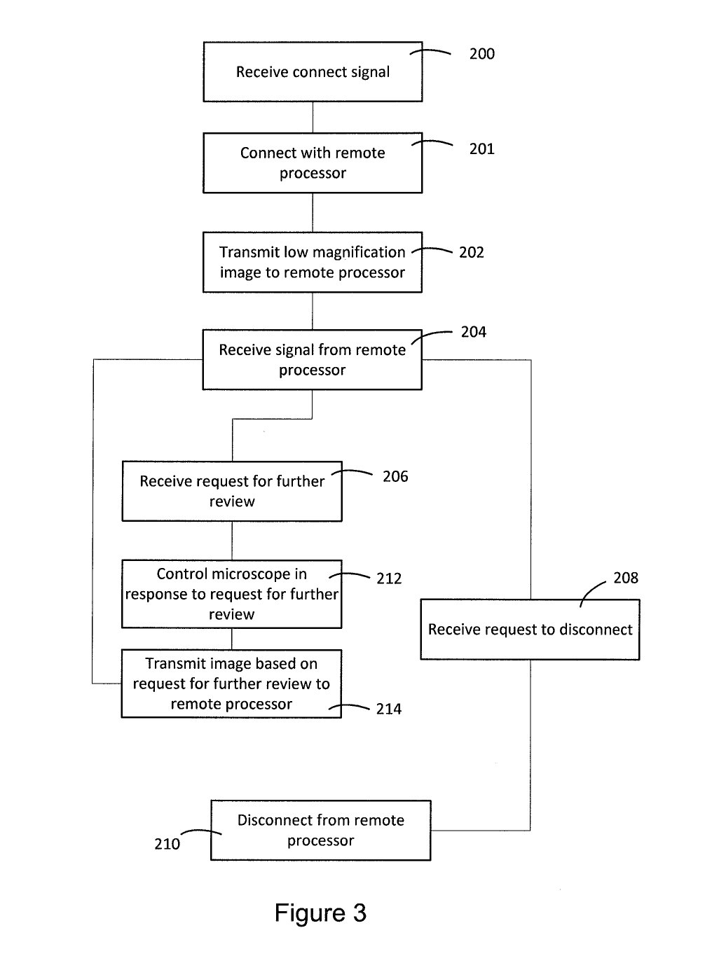

Turning to FIG. 3, a flowchart outlining a method being performed by a processor for histology sample examination is shown. In this example, the processor being discussed is the processor 21 associated with the microscope. It is again assumed that at least one slide has been prepared (along with a sample) and installed onto the motorized stage. It is further assumed that the microscope processor 21 is already on the same network as the other processor 22 such that communication between the two processors is available. As mentioned above, the two processors may be a single processor.

Initially, a signal is received by the processor to connect 200 with another processor which may be seen as the remote processor 22. If there is only one processor, there is no need to wait for this signal to be received. After a connection is completed 201, the processor 21 transmits 202 a low magnification image of at least one slide of interest to the remote processor. This low magnification image may be the pre-scan image discussed above with respect to FIG. 2.

The processor 21 then waits until it receives a signal 204 from the remote processor. This signal may include a request for further review 206 which may include an indication as to which slide (within the motorized stage) the pathologist wishes to review, the ROI and the magnification at which the pathologist wishes to review the ROI. Alternatively, if there is only one slide installed in the motorized stage, there is no need for the remote processor to transmit an indication as to which slide to review. Alternatively, the signal may be one to disconnect 208 if the review of the images or slides is complete. The communication may then be disconnected 210.

If the signal received is a request for further review, the processor controls the microscope 212 to meet the specification or specifications as requested by the processor 22 and then transmits an image based on the specification or specifications to the remote processor 214. This processor may then continue to wait for further instruction from the processor 22 by returning to 204.

In another embodiment, when a slide is to be reviewed, initially, it is loaded into the motorized stage and the slide is then scanned using an objective lens, such as a 2× objective lens, and strobe light illumination. Within the slide, six image tiles are acquired, such as per 15×15 mm button. The tiles are then digitally stitched together to form the pre-scan image (PSI). The PSI may also be seen as the low magnification image and may be displayed on the display or monitor associated with the pathologist. This image is used to assist the reviewer or pathologist in navigating the slide (using a larger viewing area) to determine ROI or ROIs. In another embodiment, the slide will be placed on an XY stage. With the aid of the cassette or slide loader, a low magnification image will be captured of the entire slide. Due to the small size of the field of view (FOV) of the microscope this will take multiple images and passes of the microscope for the full slide. Therefore, the disclosure provides a method of enlarging the contents on the slide for easier review and detection of ROIs.

After the PSI is displayed on the monitor or display, the cursor associated with the computer monitor, or the screen, is servo-linked with a XY stage of the microscope. The microscope may then be aimed at where the cursor is pointing and the image displayed on a second computer monitor. A lens changer may then—on request—provide other magnifications for reviewing the slide. In a preferred embodiment, the displays are nested and the cursor may be moved to the second screen whereby the objective of the microscope follows the movement of the cursor. In one embodiment, a mouse may be used to control the cursor, however, a joystick may also be used, such as when observing with a binocular.

To get the images quickly, a flash may be used. This allows the images to be captured while the motorized stage is in motion, as opposed to the old method of stationary image capture which takes up a lot of time. The flash freezes the image and allows for a clear capture even though the stage is moving between positions. An advantage is that there is no loss of time for stage acceleration/deceleration, stopping, waiting for settling before obtaining the image.

In an alternative embodiment, the two displays at the remote processing location may be the same computer monitors or different computer monitors whereby one computer monitor shows a low magnification image and may also be used to show the FOV location as a rectangle corresponding to the FOV of the microscope on the slide. In one embodiment, the low magnification image can be taken at any magnification and the whole or most of the slide may be displayed in one image. The second computer monitor may be linked to the integrated microscope payload such that when the reviewer moves the display pointer to a spot on the first display that area will appear on the second display. This allows the reviewer to move the cursor to the second computer display and zoom in on an area of interest or ROI. Since the reviewer may use the second computer display to assist in controlling the microscope payload, the image that the reviewer sees is preferably in real time and not a captured image. This also allows the reviewer to automatically change objectives or the lens and see the image at higher magnifications as required.

In a further embodiment, the images being displayed on the displays may be stored in a database. Once a ROI is identified and a desired magnification has been selected to see the required detail, the image can be saved. In this way a low magnification image, the locations of the ROI are marked and saved or only the ROI images are saved. The net result is data which is of a compact and manageable size after each session. This differs from the current solution which requires that all the images are collected with high magnification. In the present art, these images are collected indiscriminately at highest magnification of the entire slide, as oppose to the present disclosure, where only ROI images are collected at high magnification. Storing PSI and ROI images requires two orders of magnitude less disk space then some current embodiments. The low magnification images may be saved from the session as well and not just ROI images.

In addition, the method of the disclosure may allow for multi-mode observation, i.e. florescence, polarization, confocal as required while still maintaining the session image files compact because still only ROI high resolution images are saved.

In one specific embodiment, the disclosure may be used in the review of a prostate whole mount. In general, a prostate slice specimen is too large to fit on a slide. Currently specimen slices are cut up into multiple sections. These sections are then mounted on individual slides whereby up to four or more slides may be necessary to produce a full mount.

In an embodiment of the disclosure, these prostate slides are placed on the motorized stage and then scanned at low magnification. The scanned images may then be digitally reconstructed and shown as one whole mount image and transmitted as such to the remote processor. This image may then be displayed on a first computer display (assuming two computer displays) at the remote location as the navigation location image, as per the explanation above. The slides remain on the stage with the microscope payload as the reviewer may then use the image displayed on the first computer display to locate an area of interest or ROI. After selecting the ROI, the reviewer may then switch to the second computer display (which now displays the ROI either at the same magnification or at a higher magnification) and zoom in with the right magnification objective to clearly observe the area. The creation and transmission of this image to the second computer display is described above. Images can be saved as well as the session as per the explanation above.

In another embodiment, the disclosure may be used in 3D imaging of ROI in a specimen, sample or slide. In other words, the disclosure may produce a 3D image of an ROI i.e. tumor. In use, low magnification/resolution stack images may be taken and shown as a stack on the first computer display. The reviewer can then scan through them and then the second computer display, the reviewer may zoom in on the slide with the microscope payload and mark the boundary of the ROI with the display pointer. Once the boundary is marked on the stack a 3D image is reconstructed and basic metrology information is provided i.e. volume, location, geometry.

The advantages of the present disclosure, include, but are not limited to, the slide is available for optical examination at any time with the added benefit of digital imaging; the size of the files required in the present disclosure is considerably less than those stored in the current methods since only the relevant information gets recorded. This makes the method useful for both small and very large sample examination.

Furthermore, the present disclosure is particularly suitable for generating data for 3D histopathology, because it generates smaller and thus manageable data files. Also, scanning at low resolution is at least order of magnitude faster than in current methods rendering the present disclosure suitable for histopathology examination during the surgery.

Another advantage of the disclosure is that the method supports inclusion of other than conventional microscopy observation methods such as fluorescence, confocal. The slide evaluation session can be recorded and played back at any time on the computer monitor. Furthermore, the record of the session includes at least one relatively small JPEG file containing a low resolution scan of the slide as well as high resolution images of ROIs selected by the slide reviewer. Also, the present disclosure supports remote histopathology. If the reviewer limits himself to examination of the digital images, the reviewer may perform the review remote from the microscope. This may be performed over a computer network or even via Internet. The reviewer may need to be supported by another individual for loading the cassettes with slides to the slide autoloader.

A reduction in the time needed to automate microscope functions such as, but not limited, maintaining the instrument in focus while browsing the sample on the slide, instant refocusing after the lens change and/or matching illumination level to optical magnification. Yet a further advantage is the convenience of electronic image storage, annotation and illustrated report generation.

In an alternative embodiment, the speed of capturing PSI may be considerably improved by mapping the location of a tissue on the slide and then restricting scanning to the area containing tissue and skipping the empty areas. This can be accomplished by first capturing the image of the entire slide with the conventional CCD or CMOS camera, then computer analyzing the image for determining the boundary of the tissue sample on the slide for finally restricting the scanning area to the tissue only and skipping the empty areas on the slide.

The above-described embodiments are intended to be examples only. Alterations, modifications and variations can be effected to the particular embodiments by those of skill in the art without departing from the scope, which is defined solely by the claims appended hereto.

What is claimed is:

1. A method for histology sample examination comprising:
transmitting a low magnification image to a remote processor;
receiving further review signal from remote processor, the further review signal including region of interest (ROI) information and magnification information; and
transmitting updated image to the remote processor based on the further review signal.

2. The method of claim 1 further comprising, after receiving further review signal:
transmitting a first signal to a microscope to focus on ROI based on ROI information;
transmitting a second signal to the microscope to change lens based on magnification information; and
capturing updated image.

3. The method of claim 1 further comprising, before transmitting the low magnification image:
capturing the low magnification image.

4. The method of claim 3 wherein capturing the low magnification image comprises:
obtaining a set of image tiles of the sample; and
digitally stitching the set of image tiles to form the low magnification image.

5. The method of claim 1 further comprising:
terminating a connection with the remote processor based on a signal from the remote processor.

6. The method of claim 1 further comprising, before receiving further review signal from the remote processor:
initiating a calibration process with the remote processor.

7. The method of claim 6 wherein initiating the calibration process comprises:
establishing a servo-XY mechanism connection with the remote processor.

8. Apparatus for histology examination of a sample on a slide comprising:
a remote processing location including:
a remote processor, and
at least one display;
a microscope including:
a lens changer,
a set of lens of differing magnifications mounted to the lens changer,
an XY-servo mechanism, and
a motorized stage for supporting the slide; and
a microscope processor for controlling the microscope and for communicating with the remote processor;
wherein the remote processor is in communication with the microscope processor over a network.

9. The apparatus of claim 8 wherein the remote processing location comprises two displays wherein one display is used for displaying a low magnification scan and a second display is used for displaying a high magnification scan.

10. The apparatus of claim 8 wherein the remote processor is connected with the XY-servo mechanism.

11. A method for histology sample examination comprising:
transmitting a low magnification image to a monitor for display of the low magnification image;
receiving a further review signal, the further review signal including region of interest (ROI) information and magnification information; and
transmitting an updated image to the monitor based on the further review signal.
